(19) United States
(12) Patent Application Publication
(10) Pub. No.: US 2006/0210265 A1
(43) Pub. Date: Sep. 21, 2006

(54) Digital camera

(75) Inventor: Yuji Adachi, Sakai-shi (JP)

Correspondence Address: SIDLEY AUSTIN LLP, 717 NORTH HARWOOD, SUITE 3400, DALLAS, TX, 75201, US

(73) Assignee: KONICA MINOLTA PHOTO IMAGING, INC.

(21) Appl. No.: 11/375,156

(22) Filed: Mar. 14, 2006

(30) Foreign Application Priority Data
Mar. 16, 2005 (JP) 2005-75111

(51) Int. Cl. G03B 13/02

(52) U.S. Cl. 396/374

(57) ABSTRACT

A lens-interchangeable digital camera having a body, a taking lens that is detachably attached to the body and is driven by a motor provided in the taking lens or a motor provided in the body, a lens determining unit configured to determine a kind of the taking lens attached to the body, an electronic viewfinder that displays a live view image captured by an image sensor provided in the body, and a display controller configured to control display of the live view image by the electronic viewfinder based on determination by the lens determining unit.

### CROSS-REFERENCE TO RELATED APPLICATION

This application is based on Japanese Patent Application No. 2005-75111 filed in Japan on Mar. 16, 2005, the entire content of which is hereby incorporated by reference.

### BACKGROUND OF THE INVENTION

1. Field of the Invention

The present invention relates to a digital camera, and more particularly, to a lens-interchangeable digital camera.

2. Description of the Related Art

A lens-interchangeable digital camera in which switching can be made between an optical viewfinder and an electronic viewfinder has conventionally been proposed. As a conventional lens-interchangeable digital camera, a single-lens reflex digital camera has been disclosed that uses an optical viewfinder and an electronic viewfinder, and is capable of displaying an image capturing preparation image (live view image) taken by an image sensor on the electronic viewfinder (“live view display”) before taking an image to be recorded (image capturing for recording) and recording the image taken by the image sensor onto a memory card, that is, digital image capturing. This digital camera is capable of performing digital image capturing while performing framing or the like with the live view display using the electronic viewfinder.

In such a digital camera, in a case where the optical viewfinder is selected, when the shutter button is half depressed, the taking lens continues the lens driving by automatic focusing. In a case where the electronic viewfinder is selected, by the half depression of the shutter button, the lens driving by automatic focusing and the live view display on the electronic viewfinder are performed until focus is achieved, and after focus is achieved, automatic focusing is stopped, and only the live view display on the electronic viewfinder is performed.

The automatic focusing used by this digital camera will be described. This camera adopts the following two automatic focusing methods: an automatic focusing using a distance measurement sensor that receives reflected light from the subject to thereby detects the distance to the subject; and an automatic focusing based on a calculation of image data which is the output of the image sensor.

Of these, in the automatic focusing using the distance measurement sensor, generally, the focus shift amount is detected by detecting the phase difference between two images formed by light rays having passed through two different parts of the taking lens, and the focusing lens is driven so that the focus shift amount is minimum. In this specification, this automatic focusing will be called phase difference AF.

In the automatic focusing using the calculation of image data, generally, the contrast of, for example, a part (called “AF area”) in the vicinity of the center of the image plane, of the image data outputted from the image sensor is calculated while the focusing lens is driven little by little, and when the contrast is near the maximum value, it is determined that focus is achieved and the driving of the focusing lens is stopped at that position.

As described above, in the conventional single-lens reflex camera, the automatic focusing operation differs according to the kind of the selected viewfinder. When the optical viewfinder is selected, even after focus is achieved, automatic focusing is continued until the shutter button is fully depressed (called “continuous AF”), and when the electronic viewfinder is selected, after focus is achieved, automatic focusing is stopped (called “one-shot AF”) and only the live view display is continued. However, when a case is considered where an image of a subject moving so that the subject distance varies is captured, it is desirable that continuous AF can be selected also when the electronic viewfinder is selected.

When this is done, however, the following problem newly arises: Currently, two kinds of taking lenses exist for single-lens reflex cameras. One is an intra-lens motor driven lens in which a focusing lens is driven by a motor in the taking lens for automatic focusing, and the other is a intra-body motor driven lens in which a focusing lens is driven by a motor in the camera body for automatic focusing. Of these, in the intra-body motor driven lens, the lens driving force is transmitted through driving force transmitting mechanisms (called “lens couplers”) provided on the camera body side and the lens side and coupled together to transmit the driving force. These lens couplers have a given amount of play so that they are smoothly coupled together when the taking lens is attached to the camera body.

When the continuous AF is performed by the above-described contrast AF, it is necessary to repeat the calculation of the contrast value while frequently driving back and forth the entire taking lens or the focusing lens which is a part of the taking lens in order to obtain the peak of the contrast of the image data. That is, when the contrast value obtained in the latest calculation is compared with the contrast value obtained in the immediately preceding calculation and the contrast value has changed by a value equal to or higher than a predetermined threshold value, since there is a possibility that the focus position has moved, it is necessary to find the new focus position by moving the focusing lens back and forth and calculating the contrast. Therefore, when the contrast AF is performed by use of the intra-body motor driven taking lens, there are cases where the focusing lens frequently moves back and forth because of the play of the lens couplers. That is, even though it is attempted to move the focusing lens to the focus position while repetitively calculating the contrast of the image, since the lens couplers have the play, control cannot be performed as desired, and there are cases where the focusing lens unnecessarily moves back and forth until reaching the focus position. Naturally, even when the one-shot AF is performed, focus cannot be readily achieved.

When this occurs, since the focus position of the live view image moves back and forth as the focusing lens moves back and forth, the live view image is poor as the viewfinder image.

In addition, since the focusing lens is frequently driven back and forth, noises are caused from the lens driving mechanism such as the motor and the play of the lens couplers and such noises are offensive to the user.

To handle this problem, it is necessary for the user to make a judgment that the live view display is not selected or that the contrast AF is not driven according to the kind of the taking lens, which burdens the user with a special operation.

### SUMMARY OF THE INVENTION

A principal object of the present invention is to provide a digital camera that burdens the user with no special operation when the lens is changed.

Another object of the present invention is to provide a digital camera capable of performing appropriate automatic focusing control even when the lens is changed.

Yet another object of the present invention is to provide a digital camera having an electronic viewfinder which digital camera is capable of performing appropriate electronic viewfinder display even when the lens is changed.

Still another object of the present invention is to provide a digital camera capable of performing appropriate electronic viewfinder display and appropriate contrast AF and in which no offensive noise is caused from the lens driving mechanism when an intra-body motor driven lens is attached to the camera.

The above-mentioned objects of the present invention are attained by providing a lens-interchangeable digital camera having the following:

a body;

a taking lens that is detachably attached to the body and is driven by a motor provided in the taking lens or a motor provided in the body;

a lens determining unit configured to determine a kind of the taking lens attached to the body;

an electronic viewfinder that displays a live view image captured by an image sensor provided in the body; and

a display controller configured to control display of the live view image by the electronic viewfinder based on determination by the lens determining unit.

The above-mentioned objects of the present invention are also attained by providing a lens-interchangeable digital camera having the following:

a body;

a taking lens that is detachably attached to the body and is driven by a motor provided in the taking lens or a motor provided in the body;

a lens determining unit configured to determine a kind of the taking lens attached to the body;

an automatic focusing portion configured to perform automatic focusing; and

an automatic focusing controller configured to control automatic focusing based on determination by the lens determining unit.

The above-mentioned objects of the present invention are also attained by providing a lens-interchangeable digital camera having the following:

a body;

a taking lens that is detachably attached to the body and is driven by a motor provided in the taking lens or a motor provided in the body;

a lens determining unit configured to determine a kind of the taking lens attached to the body;

an automatic focusing portion configured to perform automatic focusing based on a calculation of an output of an image sensor provided in the body;

a lens driving controller configured to stop the driving of the taking lens when focus is achieved by the automatic focusing portion and to resume the driving of the taking lens when a result of the calculation is changed by a value higher than a predetermined threshold value; and

a threshold value setting unit configured to use a first value as the threshold value when it is determined that the attached taking lens is a lens driven by the motor provided in the taking lens, and uses a second value higher than the first value as the threshold value when the attached taking lens is a lens driven by the motor provided in the body.

These and other objects, advantages and features of the invention will become apparent from the following description thereof taken in conjunction with the accompanying drawings, which illustrate specific embodiments of the invention.

### BRIEF DESCRIPTON OF DRAWINGS

These and other objects, advantages and features of the invention will become apparent from the following description thereof taken in conjunction with the accompanying drawings in which:

FIG. 1 is a front view of a digital camera according to an embodiment of the present invention;

FIG. 2 is a rear view of the digital camera according to the embodiment of the present invention;

FIG. 3 is a front view of the digital camera according to the embodiment of the present invention when the taking lens is detached from the digital camera;

FIG. 4 is a cross-sectional view of the digital camera according to the embodiment of the present invention when an optical viewfinder is selected;

FIG. 5 is a cross-sectional view of the digital camera according to the embodiment of the present invention when the electronic viewfinder is selected;

FIG. 6 is a block diagram showing a condition where an intra-lens motor driven taking lens is attached to the digital camera according to the first embodiment of the present invention;

FIG. 7 is a block diagram showing a condition where an intra-body motor driven taking lens is attached to the digital camera according to the first embodiment of the present invention;

FIG. 8 is a block diagram showing the structure of the camera body of a digital camera according to a second embodiment of the present invention;

FIG. 9 is a block diagram showing the structure of the camera body of a digital camera according to a third embodiment of the present invention;

FIG. 10 is a flowchart showing the operation sequence of the digital camera according to the first embodiment of the present invention;

FIG. 11 is a flowchart showing the operation sequence of the digital camera according to the second embodiment of the present invention; and

FIG. 12 is a flowchart showing the operation sequence of the digital camera according to the third embodiment of the present invention.

### DESCRIPTION OF THE PREFERRED EMBODIMENTS

Hereinafter, embodiments of the present invention will be described with reference to the drawings.

### First Embodiment

A digital camera according to the first embodiment is a digital single-lens reflex camera in which the taking lens is interchangeable, and has an optical viewfinder in which the light ray having passed through the taking lens is directed toward a pentaprism by a quick return mirror and is viewed through the eyepiece, and an electronic viewfinder in which an image capturing preparation image (live view image) taken by the image sensor is displayed on the LCD (“live view display”) before an image to be recorded is taken (photographing for recording). The user selects either the optical viewfinder or the electronic viewfinder. As the taking lens, both an intra-lens motor driven lens having a motor for driving a focusing lens in the lens, and an intra-body motor driven lens that performs focusing by the power of a motor for driving the focusing lens in the camera body are attachable.

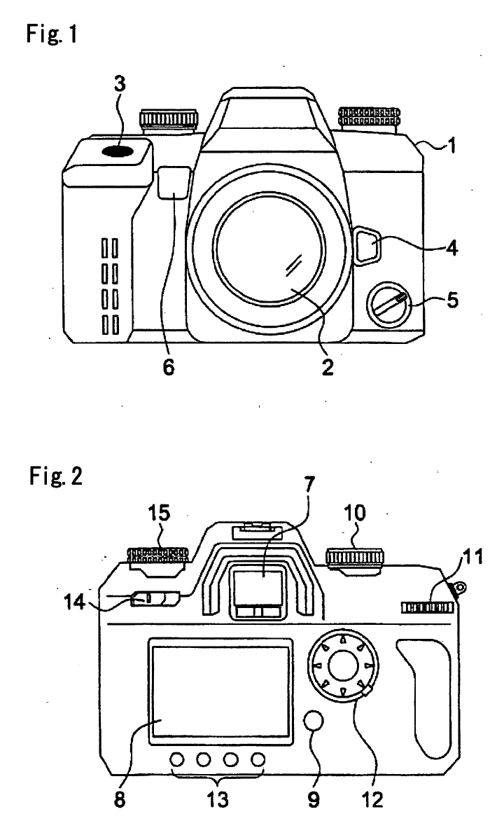

FIG. 1 is a front view of the digital camera according to the first embodiment of the present invention. In FIG. 1, reference numeral 1 represents a camera body. Reference numeral 2 represents a taking lens. Reference numeral 3 represents a shutter button. By half depressing this button (called “S1”), the live view image is obtained, and automatic focusing is started. By fully depressing the button (called “S2”), an image to be recorded is taken (image capturing for recording), and the taken image data is recorded onto a memory card (not shown). Reference numeral 4 represents a lens attaching and detaching button. Reference numeral 5 represents an automatic focusing mode setting button for setting the continuous AF in which the lens driving by automatic focusing is continued while the shutter button is half depressed, the one-shot AF in which the lens driving is stopped after focus is achieved and the manual focusing in which focusing is manually performed. Reference numeral 6 represents fill-in light that illuminates the subject for automatic focusing when the subject brightness is low.

FIG. 2 is a rear view of the camera body 1 of the digital camera. Reference numeral 7 represents an optical viewfinder. Reference numeral 8 represents an LCD which is used for displaying various pieces of information related to image capturing and is used as the electronic viewfinder. Reference numeral 9 represents a viewfinder selecting button for switching between the optical viewfinder and the electronic viewfinder. Reference numeral 10 represents an exposure mode setting dial for selecting among a program mode, an aperture priority mode, a shutter speed priority mode and a manual exposure mode. Reference numeral 11 represents a change dial used for changing the aperture value and the shutter speed. Reference numeral 12 represents a jog dial used for moving the cursor displayed on the LCD 8. Reference numeral 13 represents a setting button used for setting the menu display on the LCD 8, the frame advance of the taken image at the time of playback and the image enlargement and reduction. Reference numeral 14 represents a main switch. Reference numeral 15 represents an exposure value setting dial for setting the sensitivity and exposure correction of the image sensor.

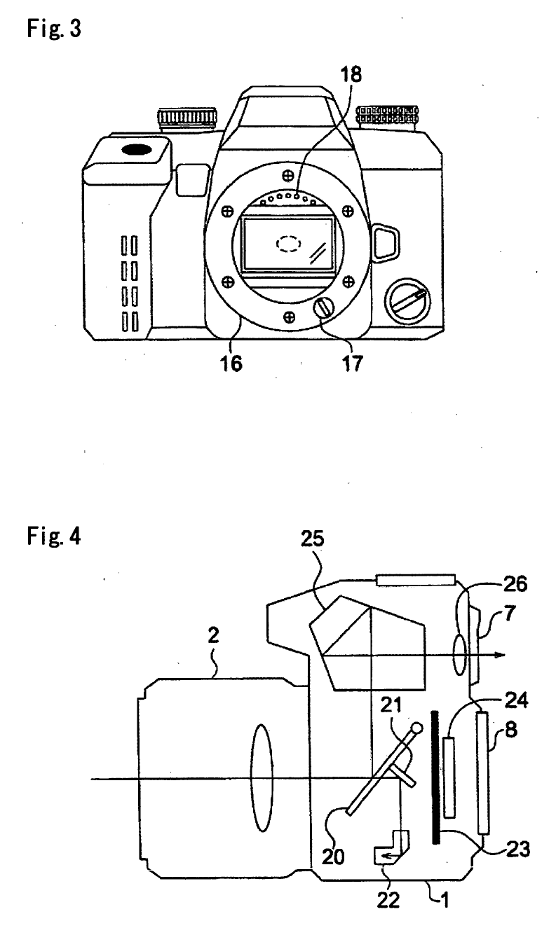

FIG. 3 is a front view of the digital camera when the taking lens is detached from the camera body 1. Reference numeral 16 represents a lens mount (lens attaching means) to which the intra-lens motor driven taking lens and the intra-body motor driven taking lens are attachable. Reference numeral 17 represents a lens coupler that transmits the driving force for lens driving from the camera body 1 to the taking lens 2. Reference numeral 18 represents electric contacts for transmitting the information on the taking lens 2 to the camera body 1 and transmitting the focusing information from the camera body 1 to the taking lens 2. When the taking lens 2 is attached, the electric contacts 18 are in contact with the electric contacts (not shown) on the taking lens 2, and information is transferred between the camera body 1 and the taking lens 2.

FIG. 4 is a cross-sectional view, including the optical axis of the taking lens 2, of the digital camera when the optical viewfinder is selected. In FIG. 4, the elements having the same functions as those of FIGS. 1 and 2 are denoted by the same reference numerals. Reference numeral 20 represents a quick return mirror that is brought onto the optical path of the light (subject light) having passed through the taking lens 2 and reflects part of the subject light toward a pentaprism 25. Reference numeral 21 represents a sub mirror that reflects the part of the subject light having passed through the light transmitting portion in the center of the quick return mirror, toward an AF module 22 that detects focus shift. The light having passed through the pentaprism 25 is viewed by the user (not shown) through an eyepiece 26. Reference numeral 23 represents a shutter. Reference numeral 24 represents an image sensor. Under this condition, since no light is directed to the image sensor 24, the live view display using the output image of the image sensor 24 and the contrast AF are impossible.

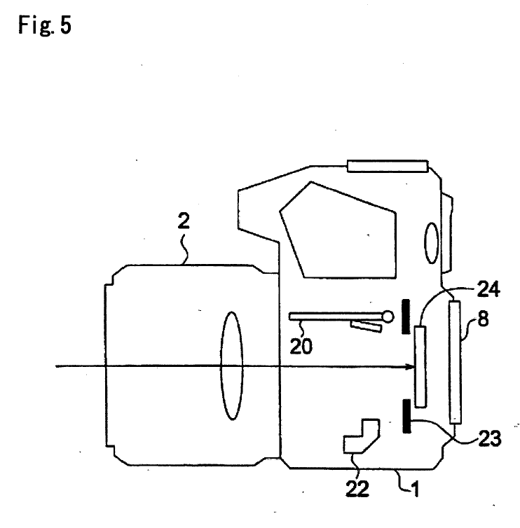

FIG. 5 is a cross-sectional view, including the optical axis of the taking lens 2, of the digital camera when the live view by the electronic viewfinder is selected. In FIG. 5, the elements having the same functions as those of FIGS. 1 and 2 are denoted by the same reference numerals. In FIG. 5, the quick return mirror and the sub mirror are moved up by non-illustrated driving unit so as to retract from the optical path of the subject light, the shutter 23 is released, and the light (subject light) having passed through the taking lens 2 is formed into an image on the surface of the image sensor 24. Under this condition, since no light is directed to the AF module 22, the phase difference AF using the AF module is impossible.

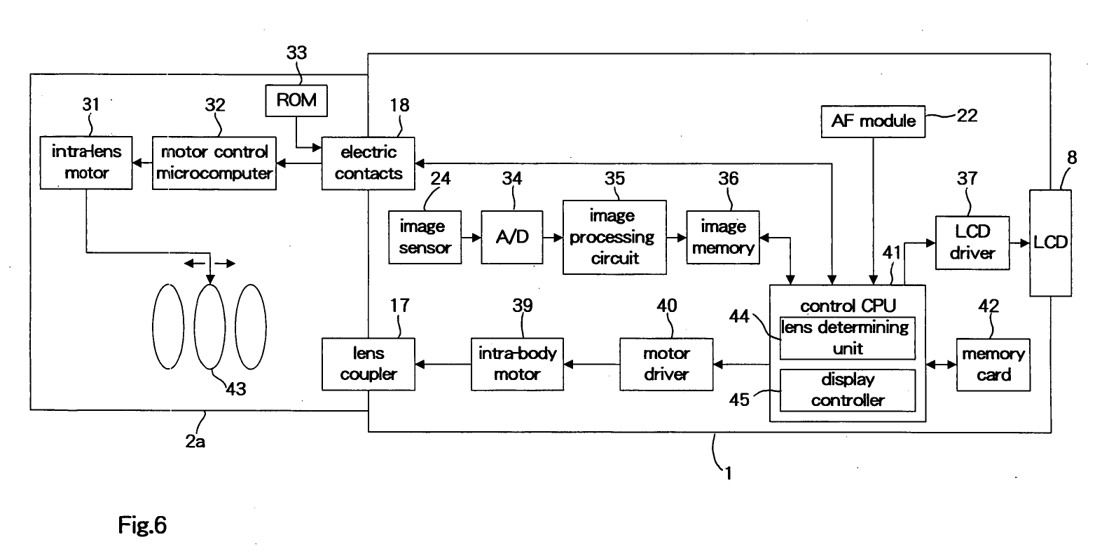

FIG. 6 is a block diagram showing the structure of the digital camera when an intra-lens motor driven taking lens 2a is attached to the camera body 1. In FIG. 6, the information related to the lens kind as to whether the attached lens is an intra-lens motor driven lens or an intra-body motor driven lens and the information related to the taking lens 2a such as the focal length are transferred from a ROM 33 of the taking lens 2a to a control CPU 41 of the camera body 1 through the electric contacts 18.

From the control CPU 41, the lens movement amount is transferred to a motor control microcomputer 32. The motor control microcomputer 32 controls an intra-lens motor 31 according to the lens movement amount received from the control CPU 41, and drives a focusing lens 43 for focusing. Reference numeral 44 represents lens determining unit for making a lens kind determination as to whether the attached taking lens is an intra-lens motor driven lens or an intra-body motor driven lens. Reference numeral 45 represents display controller for setting whether to inhibit or permit the live view.

As the image sensor 24, a CCD sensor or a CMOS sensor is used, and on the light receiving surface thereof, an image of the subject (not shown) is formed by the light having passed through the taking lens 2a. Reference numeral 34 represents an A/D converter that converts the image signal outputted from the image sensor 24 into digital image data. Reference numeral 35 represents an image processing circuit that performs black level correction, shading correction, white balance correction and gamma correction on the image data, and stores the corrected image data into an image memory 36. The image data stored in the image memory 36 is read by the control CPU 41, outputted to an LCD driver 37, and displayed on the LCD 8. The above-mentioned operations of the image sensor 24 to the LCD 8 are performed for each output frame of the image signal of the image sensor 24, and the live view image of the subject (not shown) is displayed on the LCD 8. The image data of the taken image is recorded on the memory card 42. In addition to the live view image, images recorded on the memory card 42 and information related to image capturing can be displayed on the LCD 8.

In the present embodiment, the control CPU 41 performs the signal processing for automatic focusing. The automatic focusing performed by the control CPU 41 will be described. The control CPU 41 performs the following two AF operations: the phase difference AF using the output of the AF module 22; and the contrast AF using the contrast of part of the image data.

Of these, in the phase difference AF, the focus shift amount is detected by detecting the phase difference between two images formed on the AF module 22 by light rays having passed through two different parts of the taking lens 2a and the focusing lens 43 is driven so that the focus shift amount is minimum.

In the contrast AF, the contrast of the AF area of the image data outputted from the image sensor 24 is repetitively calculated while the focusing lens 43 is driven little by little, and determining that the point where the contrast is highest is the focus point, the driving of the focusing lens 43 is stopped at that position. It is to be noted here that the calculation of the contrast is continued. When the contrast value obtained in the latest calculation is different from the contrast value obtained in the previous calculation by a value higher than a specific threshold value, it is determined that there is a possibility that in-focus state is broken for a reason such that the subject distance is changed or that the subject itself is changed, the driving of the focusing lens 43 is resumed and a new focus point is searched for. When the contrast value obtained in the latest calculation is different from the contrast value obtained in the previous calculation only by a value equal to or lower than the specific threshold value, it is determined that the focus position is not significantly changed. The threshold value may be an absolute value or a ratio to the previous contrast value.

The control CPU 41 calculates the focus shift amount or the contrast by the above-described manner, and outputs the information on the movement direction or the movement amount of the lens to the motor control microcomputer by way of the electric contacts 18. The motor control microcomputer 32 drives the intra-lens motor 31 according to the information to drive the focusing lens 43.

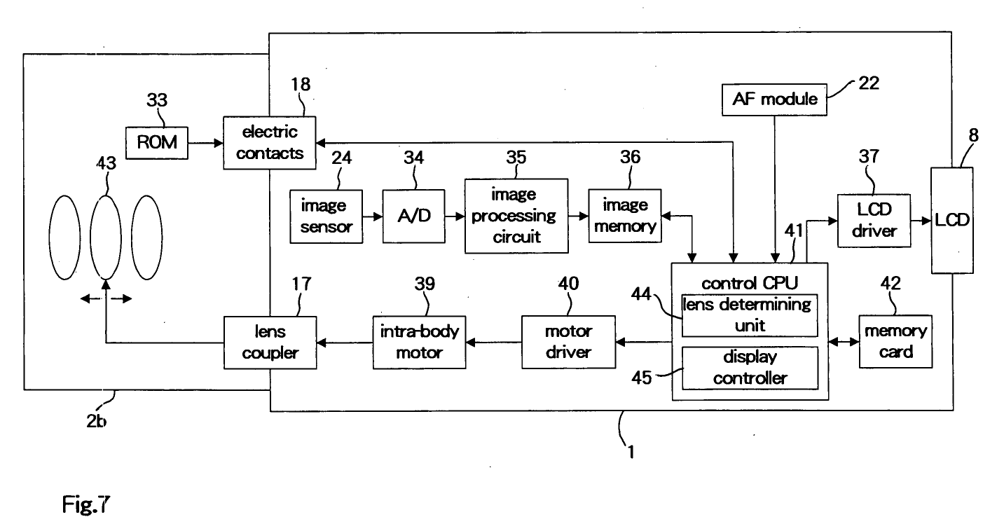

FIG. 7 is a block diagram showing the structure of the digital camera when an intra-body motor driven taking lens 2b is attached to the camera body 1. In FIG. 7, the elements having the same functions as those of FIG. 6 are denoted by the same reference numerals. The operation of the structure shown in FIG. 7 is different from that of the structure shown in FIG. 6 only in the part associated with the driving of the focusing lens 43, and the remaining parts associated with the live view image display, automatic focusing and the like are the same. Therefore, descriptions thereof are omitted, and only the part associated with the driving of the focusing lens 43 will be described.

In the structure of FIG. 7, the information on the movement direction and the movement amount of the lens is outputted from the control CPU 41 to a motor driver 40. The motor driver drives the intra-body motor 39 according to the information. This driving force is transmitted to the taking lens 2b through the lens coupler 17 to drive the focusing lens 43.

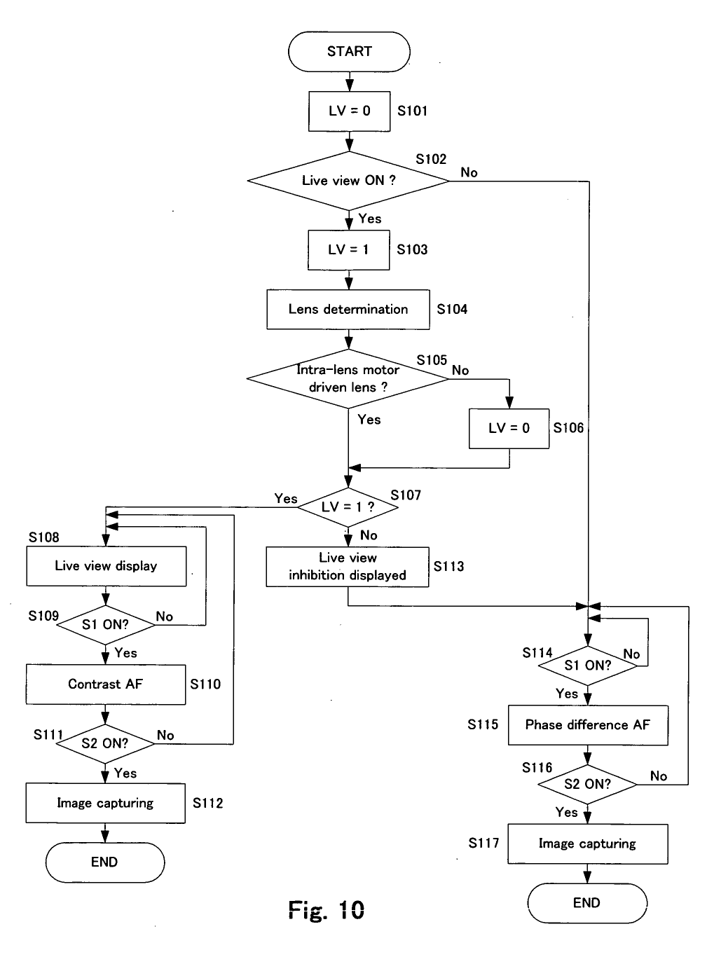

FIG. 10 is a flow chart showing the control sequence of the digital camera according to the first embodiment of the present invention. In FIG. 10, when the main switch 14 is turned on, the quick return mirror and the sub mirror are brought onto the optical path of the subject light, and at step S101, a live view permission flag LV is set to 0 to inhibit the live view.

At step S102, it is determined whether the live view by the electronic viewfinder is selected or the optical viewfinder is selected. When the live view is selected (step S102: Yes), step S103 is executed, and when it is not selected (step S102: No), step S114 is executed.

At step S103, the live view permission flag LV is set to 1 to permit the live view.

At step S104, whether the attached taking lens is the intra-lens motor driven taking lens 2a or the intra-body motor driven taking lens 2b is determined based on the information read from the ROM 33.

At step S105, it is determined whether the lens used is the intra-lens motor driven taking lens 2a or the intra-motor driven taking lens 2b. When the intra-lens motor driven taking lens 2a is used (step S105: Yes), step S107 is executed, and when it is not used (step S105: No), step S106 is executed.

At step S106, the live view permission flag LV is set to 0 to inhibit the live view.

At step S107, it is determined whether the live view permission flag LV is 1 or not. When LV is 1, that is, when the live view is permitted (step S107: Yes), step S108 is executed, and when LV is not 1, that is, when the live view is inhibited (step S107: No), step S113 is executed.

At step S108, the quick return mirror and the sub mirror are moved up so as to retract from the optical path of the subject light, and the live view display is performed on the LCD 8.

At step S109, it is determined whether the shutter button 3 is half depressed or not, that is, whether S1 is on or not. When S1 is on (step S109: Yes), step S110 is executed, and when it is not on (step S109: No), the process returns to step S108.

At step S110, the contrast AF using the image data is performed. At this step, the AF operation for one frame of the image data is performed, and the process proceeds to steps S111.

At step S111, it is determined whether the shutter button 3 is fully depressed or not, that is, whether S2 is on or not. When S2 is on (step S111: Yes), step S112 is executed, and when it is not on (step S111: No), the process returns to step S108.

At step S112, image capturing is performed, and the image data is stored onto the memory card 42.

A case where the live view is inhibited at the above-described step S107 (step S107: No) will be described. At step S113, an indication that the live view is inhibited is shown on the LCD 8 or another display means (not shown) by the display controller of the control CPU.

At step S114, it is determined whether the shutter button 3 is half depressed or not, that is, whether S1 is on or not. When S1 is on (step S114: Yes), step S115 is executed, and when it is not on (step S114: No), the determination at step S114 is repeated.

At step S115, since the quick return mirror and the sub mirror are on the optical path of the subject light, the phase difference AF using the output of the AF module 22 is executed.

At step S116, it is determined whether the shutter button 3 is fully depressed or not, that is, whether S2 is on or not. When S2 is on (step S116: Yes), step S117 is executed, and when it is not on (step S116: No), the process returns to step S114.

At step S117, image capturing is performed, and the image data is stored onto the memory card 42.

As described with reference to the flowchart of FIG. 10, according to the present embodiment, the lens determining unit 44 in the control CPU 41 automatically determines whether the taking lens attached to the camera body 1 is the intra-lens motor driven taking lens 2a or the intra-body motor driven taking lens 2a. When it is determined that the intra-body motor driven taking lens 2b is attached, the display controller 45 displays the indication that the live view is inhibited, the contrast AF is not performed, the focusing lens is not frequently driven back and forth, so that the noises that are offensive to the user are not caused from the lens driving mechanism. Since the viewfinder selection is automatically made, a special operation such that the user himself or herself determines the kind of the taking lens used and switches the viewfinder is unnecessary. The user changes the lens without concern for whether the lens used is the intra-lens motor driven taking lens 2a or the intra-body motor driven taking lens 2b, and then, the digital camera automatically selects the viewfinder display method most suitable for the lens used.

### Second Embodiment

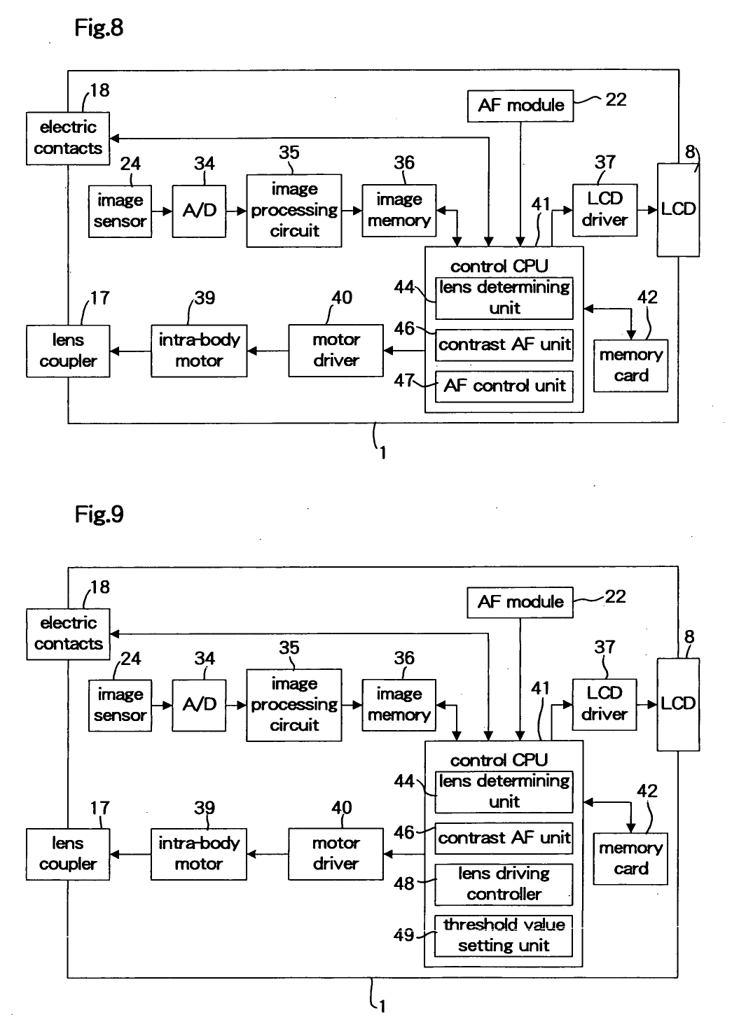

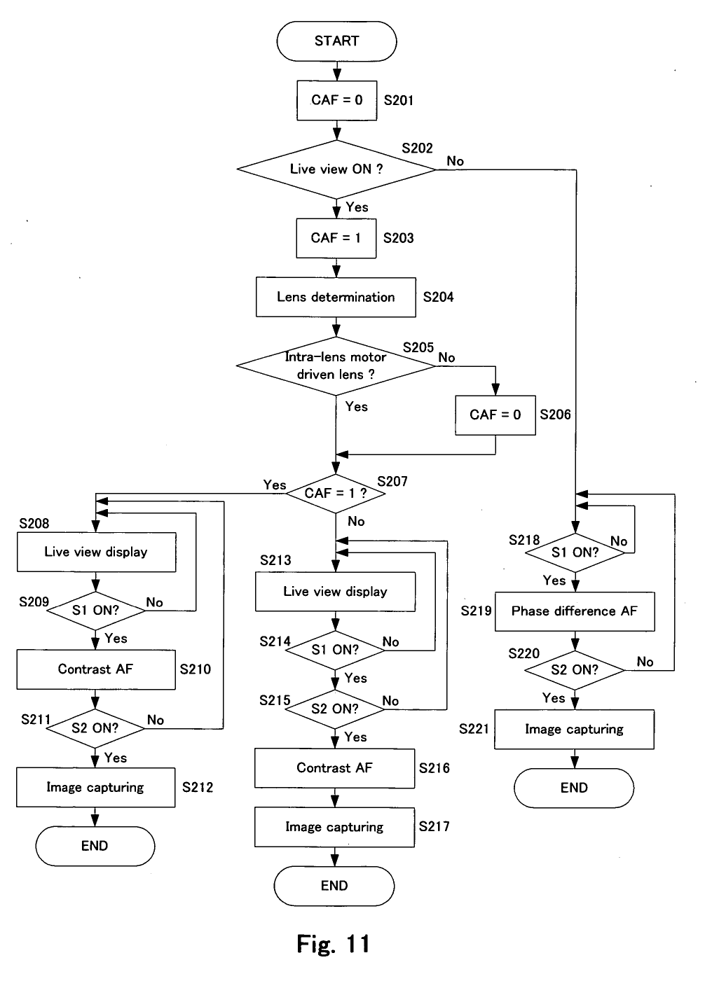

Since the structure of the hardware of the digital camera according to a second embodiment of the present invention is the same as that of the first embodiment, the description of the mechanical structure of the digital camera is omitted, and only the block diagram shown in FIG. 8 and the control sequence shown in FIG. 11 will be described.

FIG. 8 is a block diagram of the present embodiment. In this block diagram, the block diagram of only the camera body is shown, and the block diagram of the attached lens is omitted. In FIG. 8, the elements having similar functions to those of FIG. 6 are denoted by the same reference numerals. The present embodiment is different from the first embodiment only in the contents of the control CPU 41. Therefore, only the contents of the control CPU 41 will be described in this embodiment.

Reference numeral 44 represents a lens determining unit, which is the same as that of the first embodiment. The lens determining unit 44 makes a lens kind determination as to whether the attached taking lens is an intra-lens motor driven lens or an intra-body motor driven lens.

Reference numeral 46 represents contrast AF unit for performing the contrast AF based on the image data outputted from the image sensor 24.

Reference numeral 47 represents automatic focusing control unit for controlling the permission and inhibition of automatic focusing.

FIG. 11 is the control sequence of the present embodiment. In FIG. 11, when the main switch 14 is turned on, the quick return mirror and the sub mirror are brought onto the optical path of the subject light, and at step S201, a contrast AF permission flag CAF is set to 0 to inhibit the contrast AF.

At step S202, it is determined whether the live view by the electronic viewfinder is selected or the optical viewfinder is selected. When the electronic viewfinder is selected (step S202: Yes), step S203 is executed, and when it is not selected (step S202: No), step S218 is executed.

At step S203, the contrast AF permission flag CAF is set to 1 to permit the contrast AF.

At step S204, whether the attached taking lens is the intra-lens motor driven taking lens 2a or the intra-body motor driven taking lens 2b is determined based on the information read from the ROM 33.

At step S205, when the intra-lens motor driven taking lens 2a is used (step S205: Yes), step S207 is executed, and when it is not used (step S205: No), step S206 is executed.

At step S206, the contrast AF permission flag CAF is set to 0 to inhibit the contrast AF.

At step S207, it is determined whether the contrast AF permission flag CAF is 1 or not. When CAF is 1, that is, when the contrast AF is permitted (step S207: Yes), step S208 is executed, and when CAF is not 1, that is, when the contrast AF is inhibited (step S207: No), step S213 is executed.

At step S208, the quick return mirror and the sub mirror are moved up so as to retract from the optical path of the subject light, and the live view display is performed on the LCD 8.

At step S209, it is determined whether the shutter button 3 is half depressed or not, that is, whether S1 is on or not. When S1 is on (step S209: Yes), step S210 is executed, and when it is not on (step S209: No), the process returns to step S208.

At step S210, the contrast AF using the image data is performed. At this step, the AF operation for one frame of the image data is performed, and the process proceeds to steps S211.

At step S211, it is determined whether the shutter button 3 is fully depressed or not, that is, whether S2 is on or not. When S2 is on (step S211: Yes), step S212 is executed, and when it is not on (step S211: No), the process returns to step S208.

At step S212, image capturing is performed, and the image data is stored onto the memory card 42.

A case where the contrast AF is inhibited at the above-described step S207 (step S207: No) will be described. At step S213, the quick return mirror and the sub mirror are moved up so as to retract from the optical path of the subject light, and the live view display is performed on the LCD 8.

At step S214, it is determined whether the shutter button 3 is half depressed or not, that is, whether S1 is on or not. When S1 is on (step S214: Yes), step S215 is executed with no automatic focusing being performed, and when it is not on (step S214: No), the process returns to step S213.

At step S215, it is determined whether the shutter button 3 is fully depressed or not, that is, whether S2 is on or not. When S2 is on (step S215: Yes), step S216 is executed, and when it is not on (step S215: No), the process returns to step S213.

At step S216, since the quick return mirror and the sub mirror are retracted from the optical path of the subject light, the contrast AF using the image data outputted from the image sensor 24 is performed.

At step S217, image capturing is performed, and the image data is stored onto the memory card 42.

A case where the live view is not selected at the above-described step S202 (step S202: No) will be described. At step S218, it is determined whether the shutter button 3 is half depressed or not, that is, whether S1 is on or not. When S1 is on (step S218: Yes), step S219 is executed, and when it is not on (step S218: No), the determination at step S218 is repeated.

At step S219, since the quick return mirror and the sub mirror are on the optical path of the subject light, the phase difference AF using the output of the AF module 22 is executed.

At step S220, it is determined whether the shutter button 3 is fully depressed or not, that is, whether S2 is on or not. When S2 is on (step S220: Yes), step S221 is executed, and when it is not on (step S220: No), the process returns to step S218.

At step S221, image capturing is performed, and the image data is stored onto the memory card 42.

As described with reference to the flowchart of FIG. 11, according to the present embodiment, when it is determined that the intra-body motor driven taking lens 2b is attached to the camera body 1 and the live view display is selected, since the automatic focusing control unit 47 automatically inhibits the contrast AF on the live view image, the focusing lens is not frequently driven back and forth, so that the viewfinder image is never poor. In addition, the noises that are offensive to the user are never caused from the lens driving mechanism. Further, since the determination of the kind of the taking lens is automatically made, a special operation such that the user himself or herself determines the kind of the taking lens used and switches the setting of the operation is unnecessary. The user changes the lens without concern for whether the lens used is the intra-lens motor driven taking lens 2a or the intra-body motor driven taking lens 2b, and then, the digital camera automatically selects the live view display method most suitable for the lens used.

According to the present embodiment, when the intra-body motor driven taking lens 2b is attached to the camera body 1, automatic focusing is not performed when S1 is on. However, after S2 is on, since automatic focusing is performed (step S216), the taken image is high in focusing accuracy. While automatic focusing is inhibited, a manual focusing mode may be set.

### Third Embodiment

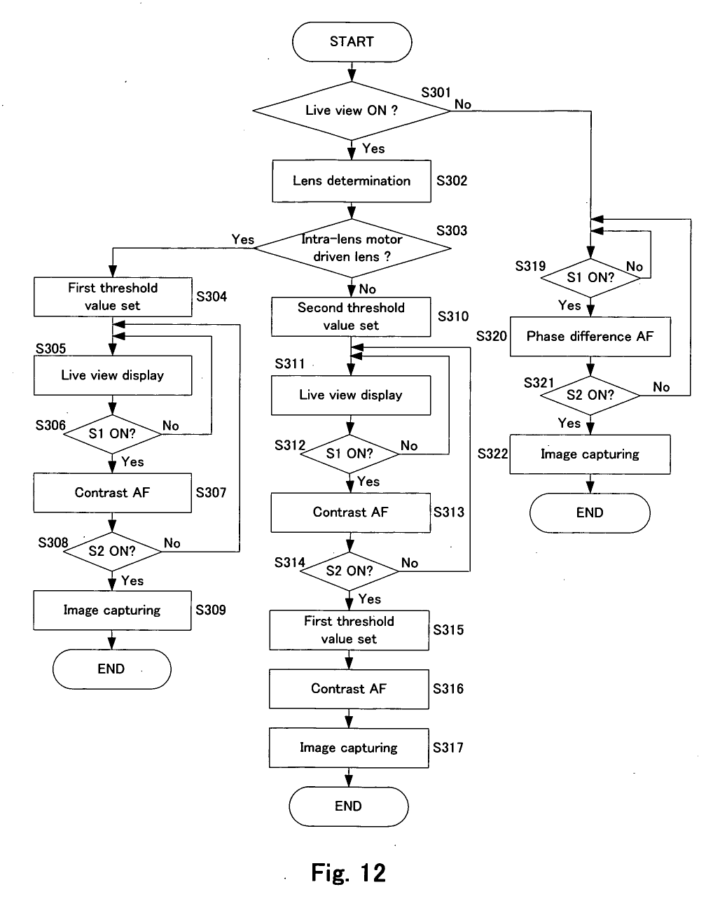

Since the structure of the hardware of the digital camera according to a third embodiment of the present invention is the same as that of the first embodiment, the description of the mechanical structure of the digital camera is omitted, and only the block diagram shown in FIG. 9 and the control sequence shown in FIG. 12 will be described.

FIG. 9 is a block diagram of the present embodiment. In this block diagram, the block diagram of only the camera body is shown, and the block diagram of the attached lens is omitted. In FIG. 9, the elements having similar functions to those of FIGS. 6 and 7 are denoted by the same reference numerals. The present embodiment is different from the first embodiment only in the contents of the control CPU 41. Therefore, only the contents of the control CPU 41 will be described in this embodiment.

Reference numeral 48 represents lens driving control unit for performing a lens driving control to resume the stopped lens driving when the repetitively calculated contrast is higher a predetermined threshold value.

Reference numeral 49 represents threshold value setting unit for setting a first value as the lens driving threshold value when the attached lens is an intra-lens motor driven lens and setting a second value as the lens driving threshold value when the attached lens is an intra-body motor driven lens.

FIG. 12 is the control sequence of the present embodiment. In FIG. 12, when the main switch 14 is turned on, the quick return mirror and the sub mirror are brought onto the optical path of the subject light, and at step S301, it is determined whether the live view by the electronic viewfinder is selected or the optical viewfinder is selected. When the live view is selected, step S302 is executed, and when it is not selected, step S319 is executed.

At step S302, whether the attached taking lens is the intra-lens motor driven taking lens 2a or the intra-body motor driven taking lens 2b is determined based on the information read from the ROM 33.

At step S303, when the intra-lens motor driven taking lens 2a is used, step S304 is executed, and when it is not used, step S310 is executed.

At step S304, the first value is set as the lens driving threshold value of the focusing lens 43. As the first value, a numerical value representative of the ratio to the maximum value of the contrast is used.

At step S305, the quick return mirror and the sub mirror are moved up so as to retract from the optical path of the subject light, and the live view display is performed on the LCD 8.

At step S306, it is determined whether the shutter button 3 is half depressed or not, that is, whether S1 is on or not. When S1 is on, step S307 is executed, and when it is not on, the process returns to step S305.

At step S307, the contrast AF using the image data outputted from the image sensor is performed. At this step, when the difference between the contrast value obtained in the latest calculation and the contrast value obtained in the previous calculation is higher than the lens driving threshold value, the driving of the focusing lens is resumed, and when the difference is equal to or lower than the lens driving threshold value, the focusing lens remains stopped. At this step, the AF operation for one frame of the image data is performed, and the process proceeds to steps S308.

At step S308, it is determined whether the shutter button 3 is fully depressed or not, that is, whether S2 is on or not. When S2 is on, step S309 is executed, and when it is not on, the process returns to step S305.

At step S309, image capturing is performed, and the image data is stored onto the memory card 42.

When the intra-body motor driven taking lens 2b is used at step S303, at step S310, the second value higher than the first value is set as the lens driving threshold value. At the second value, a numerical value representative of the ratio to the maximum value of the contrast is used.

At step S311, the quick return mirror and the sub mirror are moved up so as to retract from the optical path of the subject light, and the live view display is performed on the LCD 8.

At step S312, it is determined whether the shutter button 3 is half depressed or not, that is, whether S1 is on or not. When S1 is on, step S313 is executed, and when it is not on, the process returns to step S311.

At step S313, since the quick return mirror and the sub mirror are retracted from the optical path of the subject light, the contrast AF using the image data outputted from the image sensor 24 is performed. At this step, when the difference between the contrast value obtained in the latest calculation and the contrast value obtained in the previous calculation is higher than the lens driving threshold value, the driving of the focusing lens is resumed, and when the difference is equal to or lower than the lens driving threshold value, the focusing lens remains stopped. At this step, the AF operation for one frame of the image data is performed, and the process proceeds to steps S314.

At step S314, it is determined whether the shutter button 3 is fully depressed or not, that is, whether S2 is on or not. When S2 is on, step S315 is executed, and when it is not on, the process returns to step S311.

At step S315, the first value is set as the lens driving threshold value.

At step S316, the contrast AF using the image data is performed.

At step S317, image capturing is performed, and the image data is stored onto the memory card 42.

When the live view by the electronic viewfinder is not selected at step S301, at step S319, it is determined whether the shutter button 3 is half depressed or not, that is, whether S1 is on or not. When S1 is on, step S320 is executed, and when it is not on, the determination at step S319 is repeated.

At step S320, since the quick return mirror and the sub mirror are on the optical path of the subject light, the phase difference AF using the output of the AF module 22 is executed.

At step S321, it is determined whether the shutter button 3 is fully depressed or not, that is, whether S2 is on or not. When S2 is on, step S322 is executed, and when it is not on, the process returns to step S319.

At step S322, image capturing is performed, and the image data is stored onto the memory card 42.

The present embodiment uses two kinds of values as the lens driving threshold value used for determining whether it is necessary to drive the stopped focusing lens again or not in the contrast AF. When the intra-lens motor driven taking lens 2a is attached as the taking lens, the threshold value setting unit 49 sets the first value as the lens driving threshold value, and when the intra-body motor driven taking lens 2b is attached as the taking lens, the threshold value setting unit 49 sets the second value higher than the first value as the lens driving threshold value. By doing this, when the intra-body motor driven taking lens 2b is attached, the frequency with which the focusing lens is driven is reduced, so that the noises caused from the lens driving mechanism can be reduced to such an extent that is not offensive to the user. That is, the generation of the noises can be substantially avoided.

As described with reference to the flowchart of FIG. 12, according to the present embodiment, it is automatically determined whether the taking lens attached to the camera body 1 is the intra-lens motor driven taking lens 2a or the intra-body motor driven taking lens 2b, and when the intra-body motor driven taking lens 2b is attached and the live view display is selected, the lens driving threshold value automatically increases. Consequently, the focusing lens is less frequently moved back and forth until reaching the focus position and the frequency with which the focusing lens is driven is reduced, so that the electronic viewfinder image is never poor. In addition, the noises that are offensive to the user are never caused from the lens driving mechanism. Further, since the determination of the kind of the taking lens is automatically made, a special operation such that the user himself or herself determines the kind of the taking lens used and switches the setting of the operation is unnecessary. The user changes the lens without concern for whether the lens used is the intra-lens motor driven taking lens 2a or the intra-body motor driven taking lens 2b, and then, the digital camera automatically selects the lens driving threshold value most suitable for the lens used.

Moreover, according to the present embodiment, since the frequency of the lens driving is reduced, the electric power used for the lens driving can be reduced, so that the battery life can be prolonged.

According to the present embodiment, when the intra-body motor driven taking lens 2b is attached to the camera body 1, the lens driving threshold value is set to the second value higher than the first value when S1 is on. Consequently, the focusing accuracy of the automatic focusing is low when S1 is on and the live view image is displayed. However, after S2 is on, since the lens driving threshold value is re-set to the first value and automatic focusing is performed again (steps S315 and S316), the focus accuracy of the taken image is high.

According to the present invention, in a camera to which an intra-lens motor driven or intra-body motor driven lens is attachable and in which selection can be made between the optical viewfinder and the electronic viewfinder, the kind of the taking lens used is automatically determined and camera control suitable for the taking lens is performed. Consequently, image capturing can be performed in which it is unnecessary for the user to switch the camera setting according to the kind of the taking lens, the user is not burdened with a special operation, it never occurs that the focusing lens is frequently driven to make the electronic viewfinder image poor, and no noise is generated from the lens driving mechanism.

According to the present invention, when the attached taking lens is an intra-body motor driven lens, the live view display is automatically inhibited. Consequently, the contrast AF is not actuated, the focusing lens is not frequently driven back and forth, and the noises that are offensive to the user are never caused from the lens driving mechanism. Further, since the live view display is automatically inhibited, the viewfinder most suitable for the kind of the attached taking lens can be selected without the user being forced to perform a special operation.

According to the present invention, when the attached taking lens is an intra-body motor driven lens, automatic focusing is automatically controlled. Consequently, when an intra-body motor driven lens is attached, even when the live view image is selected, automatic focusing is set in a condition most suitable for the kind of the taking lens. Moreover, since automatic focusing is automatically controlled, the camera operation setting most suitable for the kind of the attached taking lens can be performed without the user being forced to perform a special operation.

Further, according to the present invention, when the attached taking lens is an intra-body motor driven lens, automatic focusing is automatically inhibited. Consequently, when an intra-body motor driven lens is attached, even when the live view display is selected, the focusing lens is never frequently driven, and the viewfinder image is never poor. Moreover, the noises that are offensive to the user are never caused from the lens driving mechanism. Further, since automatic focusing is automatically inhibited, the camera operation setting most suitable for the kind of the attached lens can be performed without the user being forced to perform a special operation.

Moreover, according to the present invention, when the attached taking lens is an intra-lens motor driven lens, the first value is used as the threshold value (called “lens driving threshold value”) used for determining whether it is necessary to drive the stopped focusing lens again or not, and when the attached taking lens is an intra-body motor driven lens, the lens driving threshold value is automatically set to the second value higher than the first value. Consequently, since the most suitable threshold value is set according to the kind of the taking lens, even when the live view is selected, the focusing lens is not unnecessarily driven back and forth, so that the viewfinder image is never poor. Moreover, the noises that are offensive to the user are never caused from the lens driving mechanism. Further, since the threshold value is automatically changed, the threshold value most suitable for the attached taking lens can be set without the user being forced to perform a special operation.

Although the present invention has been fully described by way of examples with reference to the accompanying drawings, it is to be noted here that various changes and modifications will be apparent to those skilled in the art. Therefore, unless otherwise such changes and modifications depart from the scope of the present invention, they should be construed as being included therein.

What is claimed is:

1. A lens-interchangeable digital camera comprising:
a body;
a taking lens that is detachably attached to the body and is driven by a motor provided in the taking lens or a motor provided in the body;
a lens determining unit configured to determine a kind of the taking lens attached to the body;
an electronic viewfinder that displays a live view image captured by an image sensor provided in the body; and
a display controller configured to control display of the live view image by the electronic viewfinder based on determination by the lens determining unit.

2. The lens-interchangeable digital camera as claimed in claim 1, wherein the display controller indicates on the electronic viewfinder an indication that the live view display is inhibited when the lens determining unit determines that the attached taking lens is a lens driven by the motor provided in the body.

3. The lens-interchangeable digital camera as claimed in claim 1, wherein the display controller indicates the live view image on the electronic viewfinder when the lens determining unit determines that the attached taking lens is a lens driven by the motor provided in the taking lens.

4. The lens-interchangeable digital camera as claimed in claim 1, wherein the taking lens is provided with a storing portion that stores lens information including a kind of lens.

5. The lens-interchangeable digital camera as claimed in claim 1, further comprising:
an optical member configured to reflect a portion of a light incident from the taking lens while transmitting a portion of the light incident from the taking lens;
an optical viewfinder;
an operation member configured to switch between the optical viewfinder and the electronic viewfinder;
a driving unit configured to bring the optical member into an optical path of a subject light passed through the taking lens when the optical viewfinder is selected by the operation member, and to retract the optical member from the optical path of the subject light passed through the taking lens when the electric viewfinder is selected by the operation member.

6. A lens-interchangeable digital camera comprising:
a body;
a taking lens that is detachably attached to the body and is driven by a motor provided in the taking lens or a motor provided in the body;
a lens determining unit configured to determine a kind of the taking lens attached to the body;
an automatic focusing portion configured to perform automatic focusing; and
an automatic focusing controller configured to control automatic focusing based on determination by the lens determining unit.

7. The lens-interchangeable digital camera as claimed in claim 6, further comprising:
an electronic viewfinder that displays a live view image captured by an image sensor provided in the body,
wherein the automatic focusing controller inhibits automatic focusing on the live view image when the lens determining unit determines that the attached taking lens is a lens driven by the motor provided in the body.

8. The lens-interchangeable digital camera as claimed in claim 6, further comprising:
an electronic viewfinder that displays a live view image captured by an image sensor provided in the body,
wherein the automatic focusing controller performs automatic focusing on the live view image when the lens determining unit determines that the attached taking lens is a lens driven by the motor provided in the taking lens.

9. The lens-interchangeable digital camera as claimed in claim 6, wherein the taking lens is provided with a storing portion that stores lens information including a kind of lens.

10. The lens-interchangeable digital camera as claimed in claim 7, wherein the automatic focusing controller sets manual focusing while automatic focusing on the live view image is inhibited when the lens determining unit determines that the attached taking lens is the lens driven by the motor provided in the body.

11. The lens-interchangeable digital camera as claimed in claim 8, wherein the automatic focusing controller performs contrast automatic focusing based upon calculation of an output from the image sensor.

12. A lens-interchangeable digital camera comprising:
a body;
a taking lens that is detachably attached to the body and is driven by a motor provided in the taking lens or a motor provided in the body;
a lens determining unit configured to determine a kind of the taking lens attached to the body;
an automatic focusing portion configured to perform automatic focusing based on a calculation of an output of an image sensor provided in the body;
a lens driving controller configured to stop the driving of the taking lens when focus is achieved by the automatic focusing portion and to resume the driving of the taking lens when a result of the calculation is changed by a value higher than a predetermined threshold value; and
a threshold value setting unit configured to use a first value as the threshold value when it is determined that the attached taking lens is a lens driven by the motor provided in the taking lens, and uses a second value higher than the first value as the threshold value when the attached taking lens is a lens driven by the motor provided in the body.

13. The lens-interchangeable digital camera as claimed in claim 12, wherein the automatic focusing portion performs contrast automatic focusing based upon the calculation from the output of the image sensor.

14. The lens-interchangeable digital camera as claimed in claim 12, wherein the taking lens is provided with a storing portion that stores lens information including a kind of lens.

15. The lens-interchangeable digital camera as claimed in claim 12, further comprising:
an electronic viewfinder that displays a live view image captured by an image sensor provided in the body,
wherein the threshold value setting unit uses the second value higher than the first value as the threshold value for automatic focusing on the live view image when the lens determining unit determines that the attached taking lens is the lens driven by the motor provided in the body.

16. The lens-interchangeable digital camera as claimed in claim 15, wherein the threshold value setting unit uses the first value as the threshold value for automatic focusing on an image to be recorded when the lens determining unit determines that the attached taking lens is the lens driven by the motor provided in the body.
